(19) United States
(12) Patent Application Publication
(10) Pub. No.: US 2006/0272921 A1
(43) Pub. Date: Dec. 7, 2006

(54) Banknote acceptor using ultraviolet ray for verification

(75) Inventors: Tien-Yuan Chien, Taipei City (TW); Shoe-Po Chan, Taipei City (TW); Yueh-Ping Hsu, Sanchung City (TW)

Correspondence Address: RABIN & Berdo, PC, 1101 14TH STREET, NW, SUITE 500, WASHINGTON, DC, 20005, US

(73) Assignee: INTERNATIONAL CURRENCY TECHNOLOGIES CORPORATION

(21) Appl. No.: 11/501,108

(22) Filed: Aug. 9, 2006

Related U.S. Application Data
(63) Continuation-in-part of application No. 10/602,589, filed on Jun. 25, 2003, now abandoned.

(51) Int. Cl. G07D 7/00; G07F 7/04; G06K 9/00; G06K 7/00

(52) U.S. Cl. 194/207

(57) ABSTRACT

A banknote acceptor is disclosed to have a banknote verification assembly detachably mounted in a housing for verifying the authenticity of the inserted banknote by means of an optical transmitter module, which uses an UV LED to emit UV light through the inserted banknote, and an optical receiver module, which uses a phototransistor to receive light passed from the UV LED through the banknote and to produce a corresponding output signal indicative of the fluorescent reaction of the fluorescent characteristics of fluorescent filaments of the paper material or the fluorescent reaction of the ink of the inserted banknote for enabling a control unit to verify the authenticity of the inserted banknote and for enabling a banknote holding down mechanism to force the verified banknote into a money box and hold it in place.

This application is a Continuation-In-Part of my patent application, Ser. No. 10/602,589, filed Jun. 25, 2003.

### BACKGROUND OF THE INVENTION

1. Field of the Invention

The present invention relates to vending machines and the like and, more specifically, to a banknote acceptor for use in a vending machine or money exchanging machine, which uses ultraviolet light to check the fluorescent reaction of the paper material/ink of the inserted banknote, enabling a control unit to verify the authenticity of the inserted banknote.

2. Description of the Related Art

Following development of technology, automatic vending machines (such as card venders, ticket venders, coin exchangers, and the like) have been developed and intensively used in public places. Regular vending machines include two types, one accepting coins and the other accepting banknotes.

However, following the use of banknote in transaction of commodities, the problem of counterfeit money bothers traders and consumers. Following fast development of computer technology, people may use computer to scan, cope, or print genuine banknotes for making counterfeit banknotes. In order to prevent imitation, a banknote has visible anti-imitation designs on the material, ink, or emblem for easy verification of its authenticity visually, and invisible anti-imitation designs that can be verified only by a machine or implement. A regular banknote acceptor uses rollers to take in the banknote, a magnetic head to touch the center of the major axis of banknote and to further produce a specific mark for comparison with a predetermined reference value so as to verify the authenticity and value of banknote. Because the magnetic head frequently touches the ink of banknotes, it will be contaminated easily. When contaminated, the magnetic head must be cleaned or repaired. Further, a counterfeit banknote maker may use a copy machine with a magnetic ink to make counterfeit banknotes, which can pass the examination of conventional banknote acceptors.

Nowadays, modern banknote acceptors use optical devices to verify the authenticity of banknotes. U.S. Pat. No. 6,101,266 discloses an apparatus and method of determining conditions of banknotes. According to this design, the apparatus comprises a note transport, which moves the note past transversely spaced spot sensing assemblies. Each spot sensing assembly includes four emitters. Each of the emitters produces radiation at different wavelengths. The spot sensing assemblies include a reflectance detector and a transmission detector, which are disposed on opposed sides of the passing note. The emitters direct radiation onto test spots on the passing note. Radiation reflected from and transmitted through the test spots is detected by the respective reflector and transmission detectors. A control circuit produces sensed values that correspond to the detected radiation. A data store in operative connection with the control circuit comprises memories that include stored data representative of transition and reflectance values for know note types. The control circuit calculates a level of correlation between the stored values and the sensed values. By comparing the correlated values to threshold values, the control circuit is operative to determine the type of note and other conditions such as if a note is worn, soiled, or a doubles note. This design of apparatus for determining a condition of a note has numerous drawbacks as follows:

1. Banknotes must be aligned so that spaced spot sensing assemblies can detect the respective spots on the passing note.

2. Because different countries issue different banknotes having different characteristics, the memories must have a sufficient big capacity to store data representative of transition and reflectance values for know note types for comparison.

3. Spot sensing assembles use prisms to refract light from light emitting diodes onto the respective spots on the passing banknote for detection. The adjustment of the relative positioning between the prisms and the light emitting diodes is important and must be accurate.

4. A precision calculation is necessary to determine the conditions of the passing banknote after radiation of the passing banknote by the spaced spot sensing assemblies. This calculation procedure takes much time that brings a barrier to the use of the banknote acceptor, i.e., this design of banknote acceptor is not suitable for use in an automatic vending machine.

5. Because the spot sensing assemblies are precision devices, the manufacturing process of the apparatus is complicated, resulting in a high manufacturing cost.

Further, regular ATMs (Auto Teller Machines) or banknote counting machines commonly use an ultraviolet lamp tube to radiate notes. When a genuine banknote is radiated by ultraviolet light, red, green and blue fluorescent filaments are seen irregularly arranged on the banknote. When a counterfeit banknote is radiated by ultraviolet light, no fluorescent filaments are seen on the counterfeit banknote, and the counterfeit banknote shows a bleached fluorescent reaction.

However, a banknote acceptor using an ultraviolet lamp tube is not suitable for use in an automatic vending machine because the ultraviolet lamp tube tends to be moistened, causing a short circuit. Further, a fluorescent lamp tube is fragile and not reclaimable, and attenuates quickly with use. Other drawbacks of fluorescent lamp tubes include high power consumption, high heat level, and short service life.

Therefore, it is desirable to provide a banknote acceptor that eliminates the aforesaid problems.

### SUMMARY OF THE INVENTION

The present invention has been accomplished under the circumstances in view. It is the main object of the present invention to provide a banknote acceptor, which directly radiates the inserted banknote with ultraviolet light for quick verification, thereby providing high accuracy and high reliability.

It is another object of the present invention to provide a banknote acceptor, which uses an ultraviolet light emitting diode to radiate the inserted banknote with ultraviolet light for quick verification for the advantages of no warm-up time, quick reaction speed, small size, low power consumption, low pollution, high brightness, and long service life.

It is still another object of the present invention to provide a banknote acceptor, which allows the housing thereof to be detachably selectively attached with one of a set of banknote verification assemblies that fit different kinds of banknotes issued from different banks in different countries.

It is still another object of the present invention to provide a banknote acceptor, which uses a communication interface module to connect the control unit thereof to an external main unit so that the user can use the external main unit to set the fluorescent reference values set in the control unit.

To achieve these and other objects of the present invention, the banknote acceptor comprises a housing, the housing comprising an insertion slot in a face panel thereof for the insertion of a banknote, a banknote passage, the banknote passage having a front end in communication with the insertion slot and a rear end, a banknote holding down mechanism provided at the rear end of the banknote passage, the banknote holding down mechanism comprising a holding down plate for forcing a banknote out of the banknote passage into a money box and holding the banknote in place, and conveyer means adapted to deliver a banknote from the insertion slot through the banknote passage to the banknote holding down mechanism; a money box connected to the housing for receiving each banknote from the banknote holding down mechanism; and a banknote verification assembly mounted in the housing and adapted to verify the authenticity of a banknote being inserted into the insertion slot for enabling the verified banknote to be delivered to the banknote passage and then the banknote holding down mechanism. The banknote verification assembly comprises a transmitter holder base, the transmitter holder base having a detection side; a receiver holder base, the receiver holder base having a detection side facing the detection side of the transmitter holder base and defining a banknote path in communication between the insertion slot and the banknote passage; an optical transmitter module mounted in the detection side of the transmitter holder base and facing the banknote path, the optical transmitter module comprising at least one ultraviolet light emitting diode adapted to emit ultraviolet light onto the banknote being inserted into the insertion slot and the banknote path; an optical receiver module mounted in the detection side of the receiver holder base and facing the banknote path, the optical receiver module comprising at least one phototransistor adapted to receive ultraviolet light passed from the optical transmitter module through the banknote being inserted into the insertion slot and the banknote path and to produce a corresponding output signal carrying fluorescent characteristics of the banknote; a control unit adapted to receive the outputted signal of the optical receiver module and to compare the characteristics of the banknote with a reference value set therein so as to determined the authenticity of the received banknote; and a communication interface module adapted to connect the control unit to an external main unit for enabling the external main unit to edit the reference value.

### BRIEF DESCRIPTION OF THE DRAWINGS

FIG. 1 is an exploded view of a banknote acceptor according to the present invention.

FIG. 1A is a side view in section of the banknote acceptor according to the present invention.

FIG. 2 is a circuit block diagram of the present invention.

FIG. 3 is a circuit diagram of the optical transmitter module and the optical receiver module according to the present invention.

FIG. 4 is a detailed circuit diagram of the optical transmitter module according to the present invention.

FIG. 5 is a detailed circuit diagram of the optical receiver module according to the present invention.

FIG. 6A is a circuit diagram of the control unit according to the present invention (I).

FIG. 6B is a circuit diagram of the control unit according to the present invention (II).

FIG. 6C is a circuit diagram of the control unit according to the present invention (III).

FIG. 6D is a circuit diagram of the control unit according to the present invention (IV).

FIG. 7 is a circuit diagram of the power module according to the present invention.

FIG. 8A is a circuit diagram of the communication interface module according to the present invention (I).

FIG. 8B is a circuit diagram of the communication interface module according to the present invention (II).

FIG. 9 is a circuit diagram of the transmission module according to the present invention.

FIG. 10 is an operation flow of the present invention.

### DETAILED DESCRIPTION OF THE PREFERRED EMBODIMENT

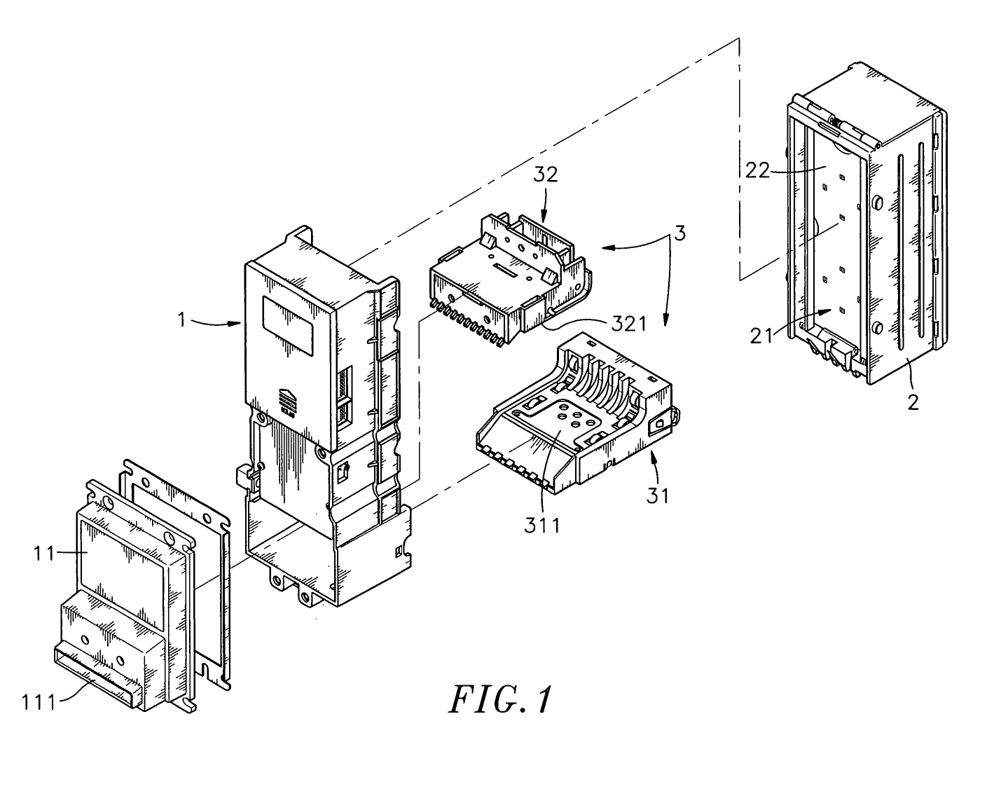

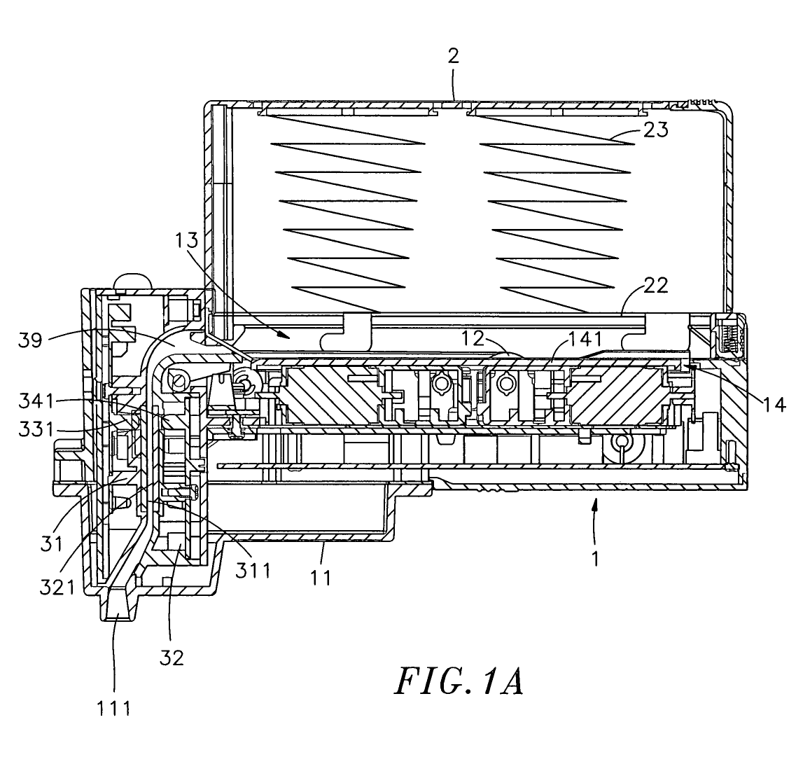

Referring to FIGS. 1 and 1A, a banknote acceptor is shown comprised of a housing 1, a money box 2, and a banknote verification assembly 3.

The housing 1 is provided with a face panel 11, which has an insertion slot 111. The banknote verification assembly 3 is detachably provided at the back side of the face panel 11 inside the housing 1 and electrically connected to the housing 1 for verifying the authenticity of a banknote being inserted into the insertion slot 111. The housing 1 comprises a conveyer 12, a banknote passage 13, and a banknote holding down mechanism 14. After verified by the banknote verification assembly 3, the conveyer 12 delivers the verified banknote from the insertion slot 111 into the banknote passage 13 and then the banknote holding down mechanism 14, for enabling a holding down plate 141 of the banknote holding down mechanism 14 to force the verified banknote into the money box 2 that is fastened to the housing 1, and then to hold the received banknote in the money box 2.

The money box 2 is a hollow container fastened to the housing 1, having a banknote receiving opening 21, a plurality of spring members 23 mounted on the inner surface of the bottom wall thereof facing the banknote receiving opening 21, and a bearing board 22 supported on the spring members 23 and movable relative to the banknote receiving opening 21 for bearing banknotes received from the banknote holding down mechanism 14.

The banknote verification assembly 3 is detachably connected to the back side of the face panel 11 of the housing 1, comprising a transmitter holder base 31, a receiver holder base 32, an optical transmitter module 33 mounted in a detecting side 311 of the transmitter holder base 31, an optical receiver module 34 mounted on the detecting side 321 of the receiver holder base 32 and facing the optical transmitter module 33 at the detecting side 311 of the transmitter holder base 31. A banknote path 39 is defined between the two detecting sides 311 and 321. The optical transmitter module 33 is comprised of at least one ultraviolet LED (light emitting diode) 331. The optical receiver module 34 comprises a phototransistor 341. Ultraviolet light from the ultraviolet LED 331 passes across the banknote path 39 to the phototransistor 341.

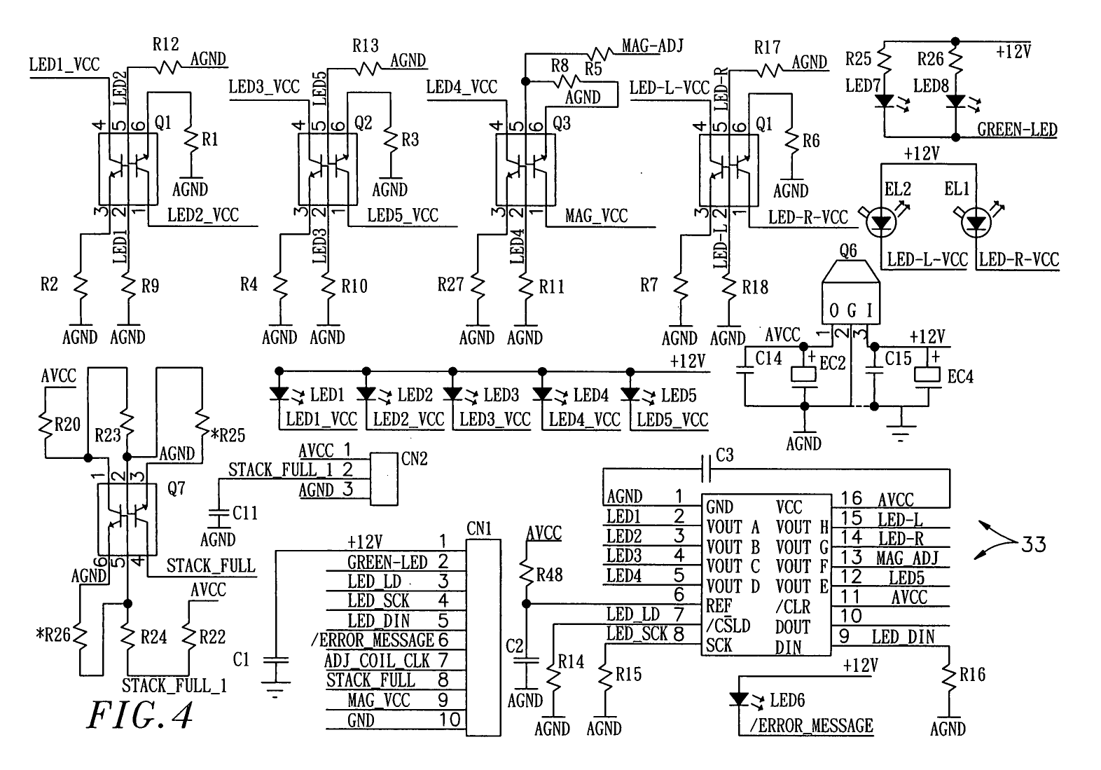

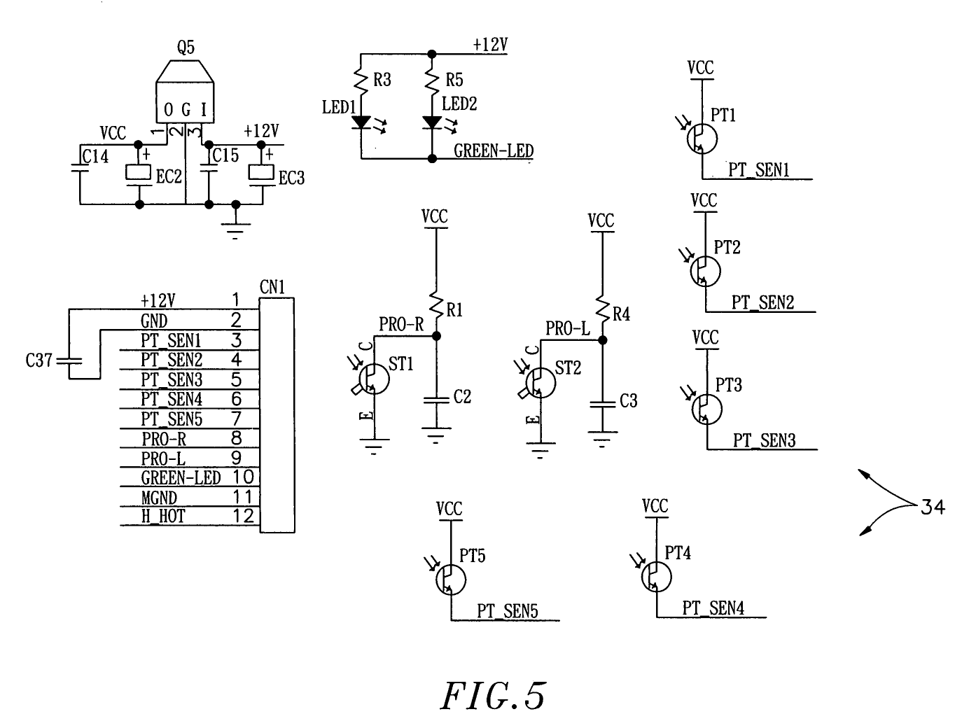

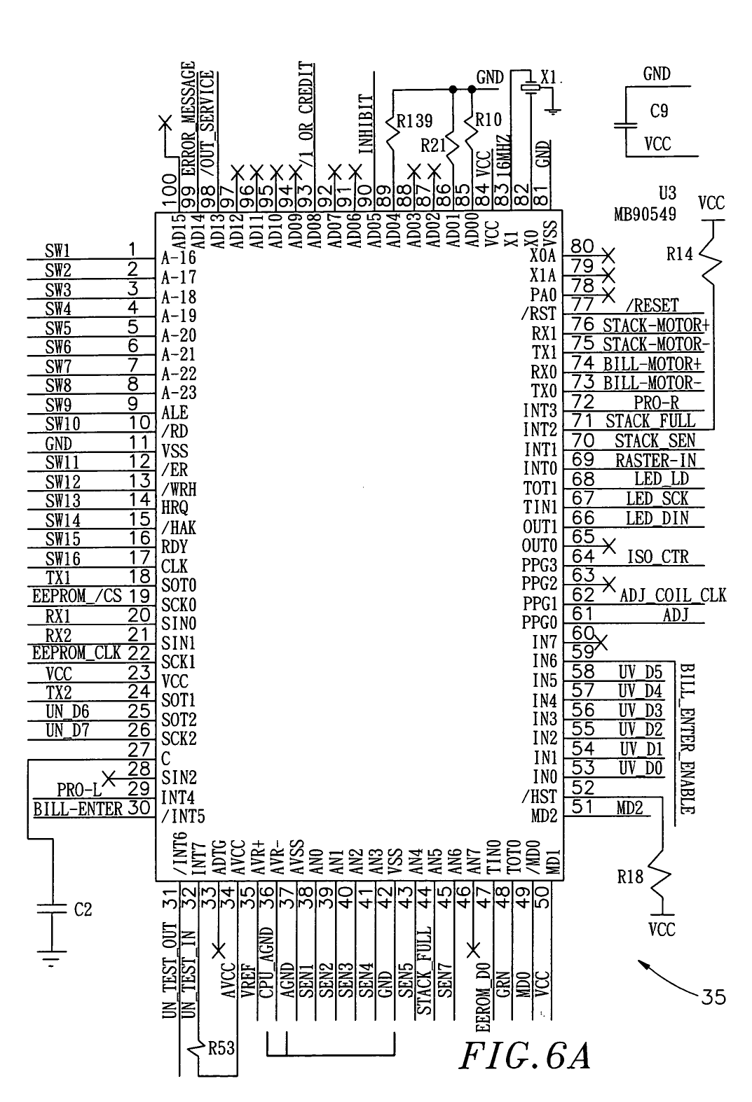

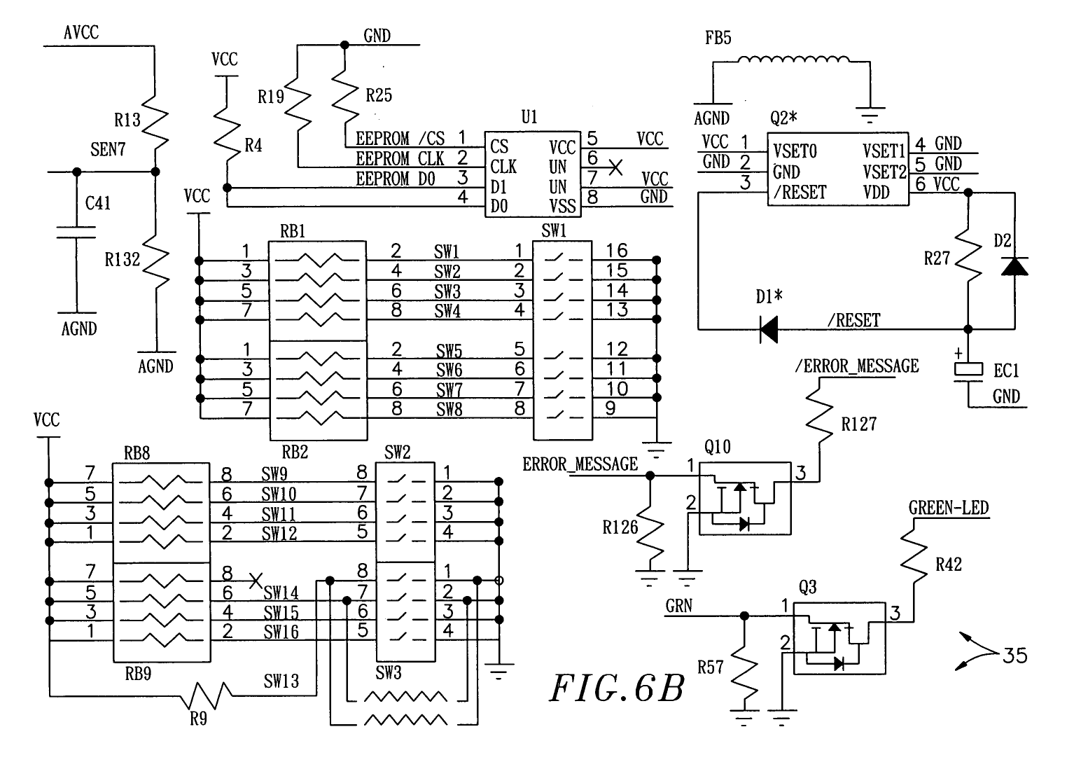

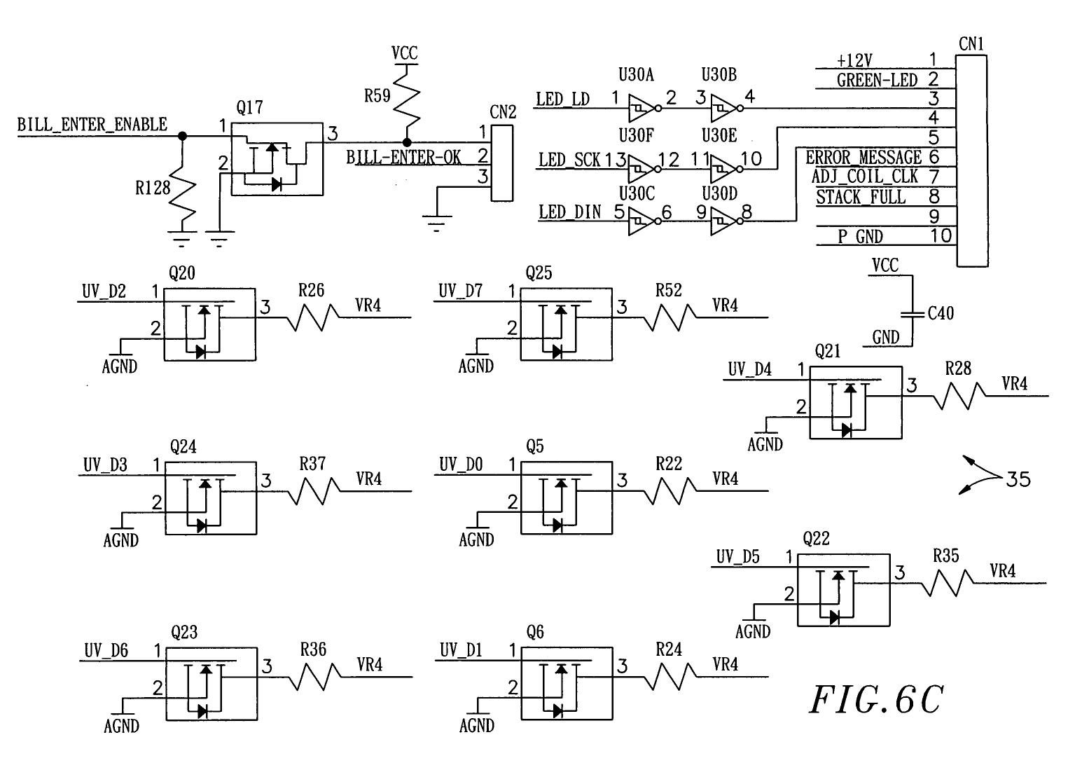

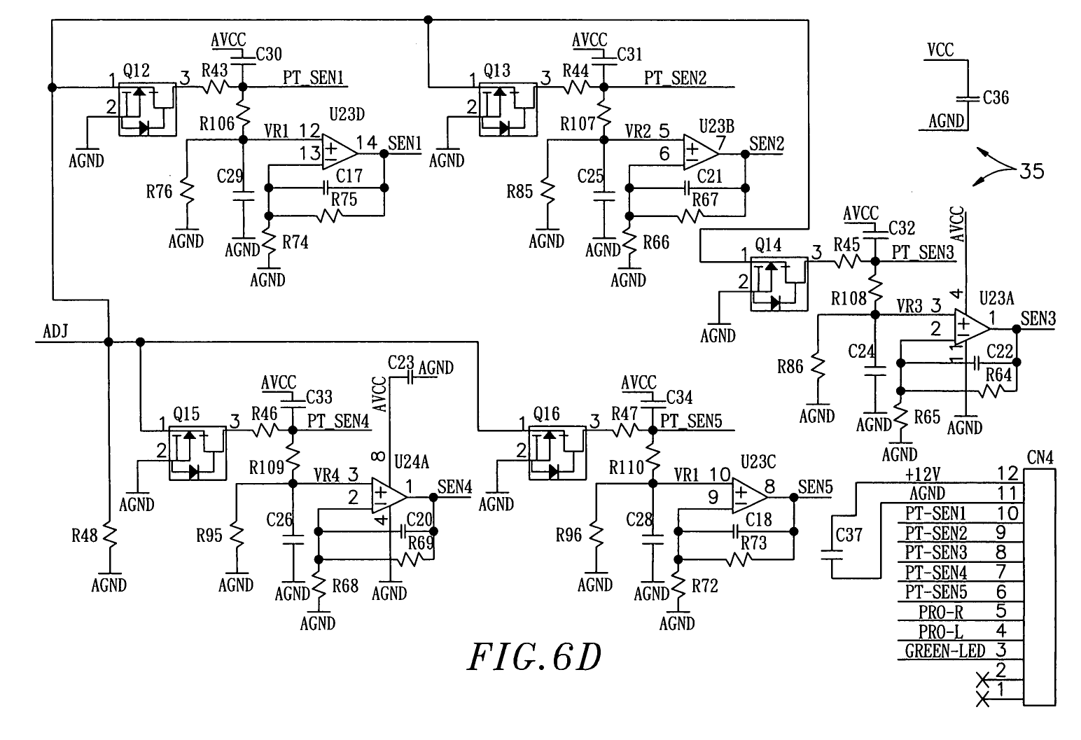

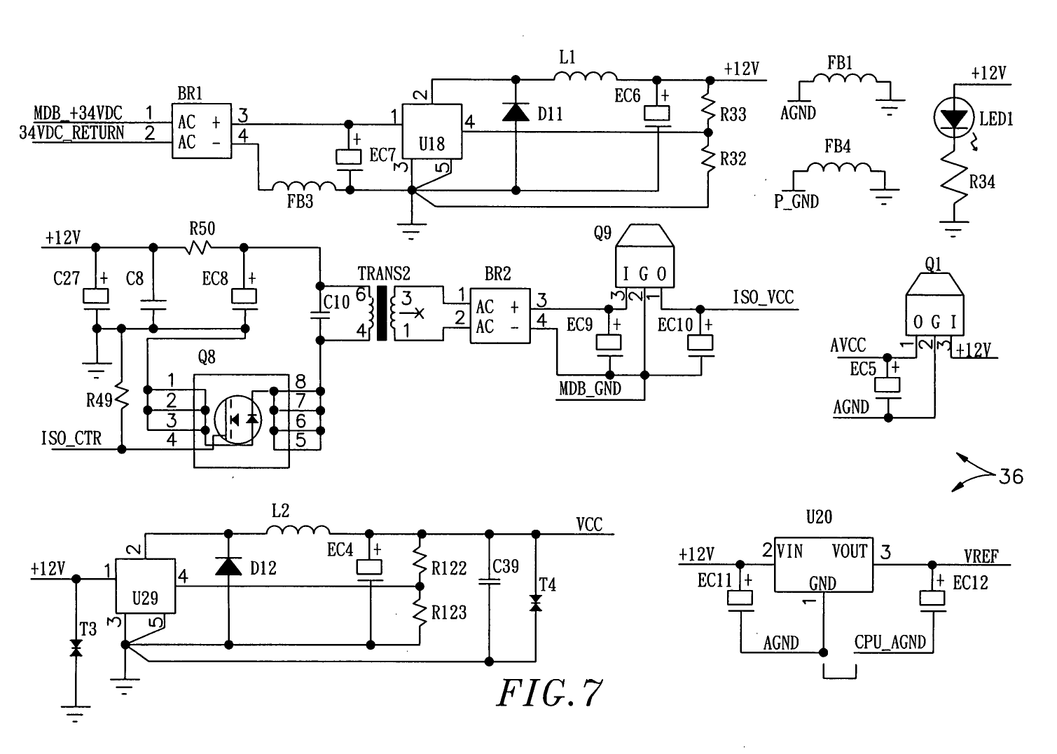

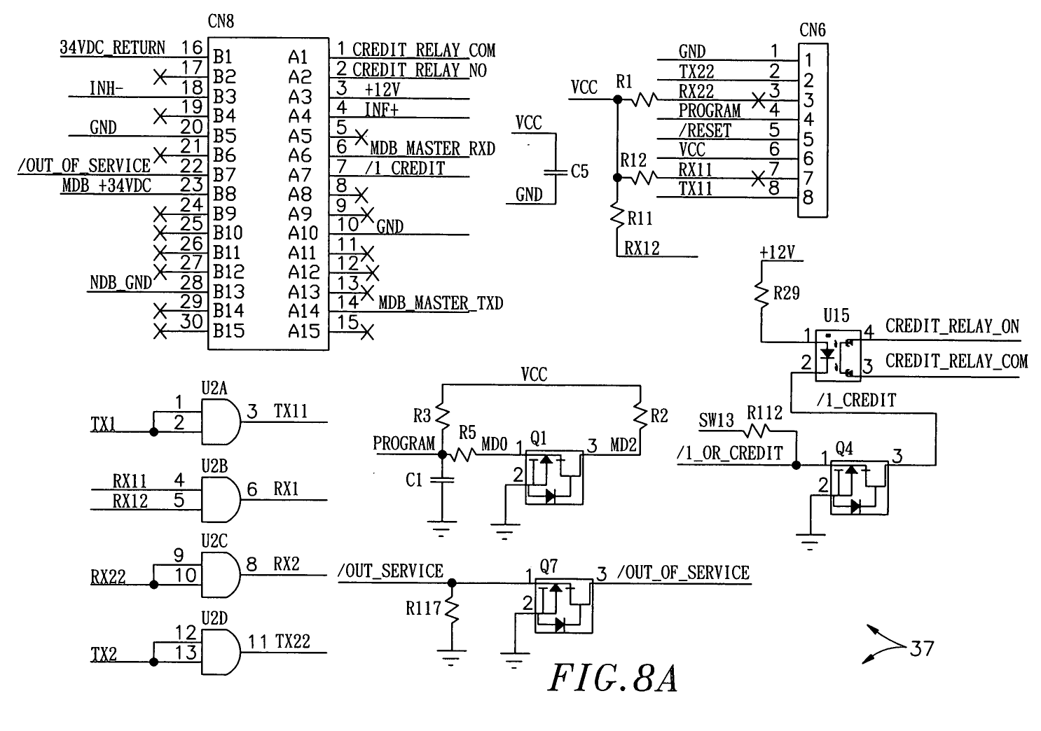

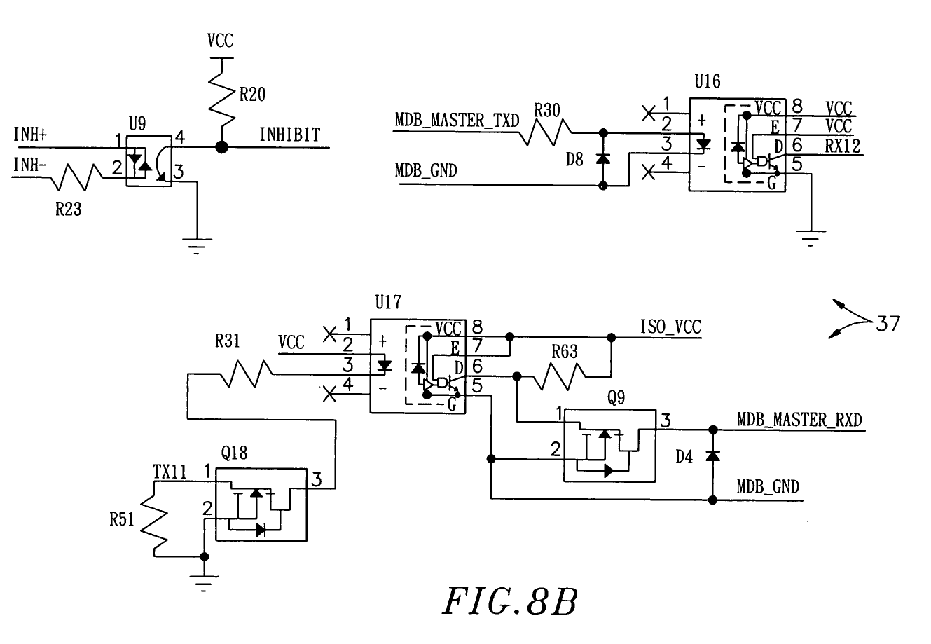

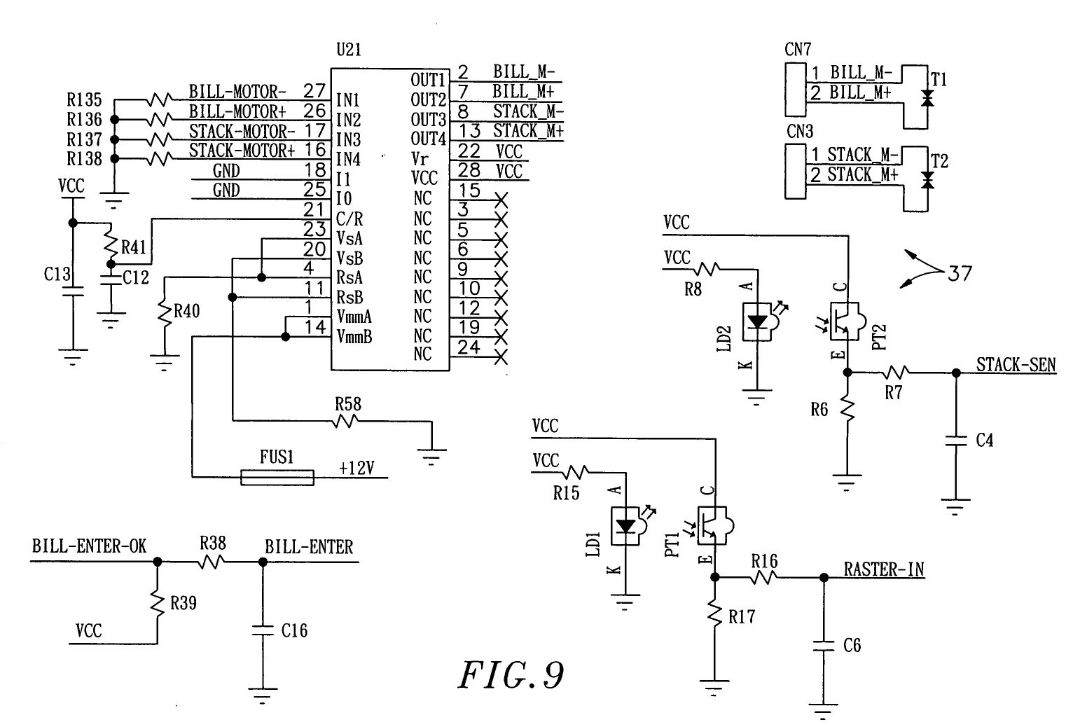

With respect to the circuit layout of the optical transmitter module 33 of the banknote verification assembly 3, please refer to FIGS. 3 and 4. With respect to the circuit layout of the optical receiver module 34 of the banknote verification assembly 3, please refer to FIGS. 3 and 5. The banknote verification assembly 3 further comprises a control unit 35 (see also FIGS. 6A, 6B, 6C, and 6D), a power module 36 (see also FIG. 7), a communication interface module 37 (see also FIGS. 8A and 8B), and a transmission module 38 (see also FIG. 9). The control unit 35 controls the operation of the operation of the optical transmitter module 33, the optical receiver module 34, the communication interface module 37 and the transmission module 38 subject to an operating program set therein.

Thus, the banknote acceptor of the present invention can be used in an automatic vending machine or coin exchanger. When a banknote is inserted into the insertion slot 111 of the face panel 11 during the use of the banknote acceptor, the banknote entered the path 39 between the transmitter holder base 31 and receiver holder base 32 of the banknote verification assembly 3 where the ultraviolet LED 331 emits ultraviolet light onto the banknote for authenticity verification. This authenticity verification can be achieved by either of the following two ways. One way is to verify the paper quality of the banknote. When a genuine banknote is radiated by ultraviolet light, red, green and blue fluorescent filaments are seen irregularly arranged on the banknote. When a counterfeit banknote is radiated by ultraviolet light, no fluorescent filaments are seen on the counterfeit banknote, and the counterfeit banknote shows a bleached fluorescent reaction. Therefore, after received the light passed through the banknote being delivered through the banknote path 38, the phototransistor 341 provides a corresponding detection signal to the control unit 35 for processing, so as to verify the authenticity of the detected banknote. The other way of verifying the authenticity of a banknote is to check the ink of the banknote. Under the radiation of ultraviolet light, the ink of the banknote under detection is excited to produce a fluorescent light, and the phototransistor 341 detects the fluorescent light thus produced for further processing and verification by the control unit 35.

Therefore, the invention verifies the authenticity of the inserted banknote by means of the radiation of ultraviolet light without the application of an additional specific area pickup and equation calculation procedure. This banknote verification procedure is simple. Further, the invention uses ultraviolet light 331 for the advantages of no warm-up time, quick reaction speed, small size, low power consumption, low pollution, high brightness, and long service life. By means of the aforesaid design, the banknote verification of the invention is highly accurate and reliable.

After verification of the authenticity of the inserted banknote, the conveyer 12 of the housing 1 is started to convey the verified banknote through the banknote passage 13 to the banknote holding down mechanism 14, for enabling the holding down plate 141 of the banknote holding down mechanism 14 to force the banknote into the banknote receiving opening 21 of the money box 2 and to hold the banknote on the bearing board 22 against the spring members 23.

Further, banknotes of different values have different lengths and widths, and employ different anti-counterfeit techniques. The housing 1 can be detachably selectively attached with one of a set of banknote verification assemblies 3 that fit different kinds of banknotes issued from different banks in different countries.

Further, a security device (not shown) may be installed in the housing 1 to provide a secondary protection, prohibiting a person from pulling back the inserted genuine banknote with a wire, adhesive tape, or like means.

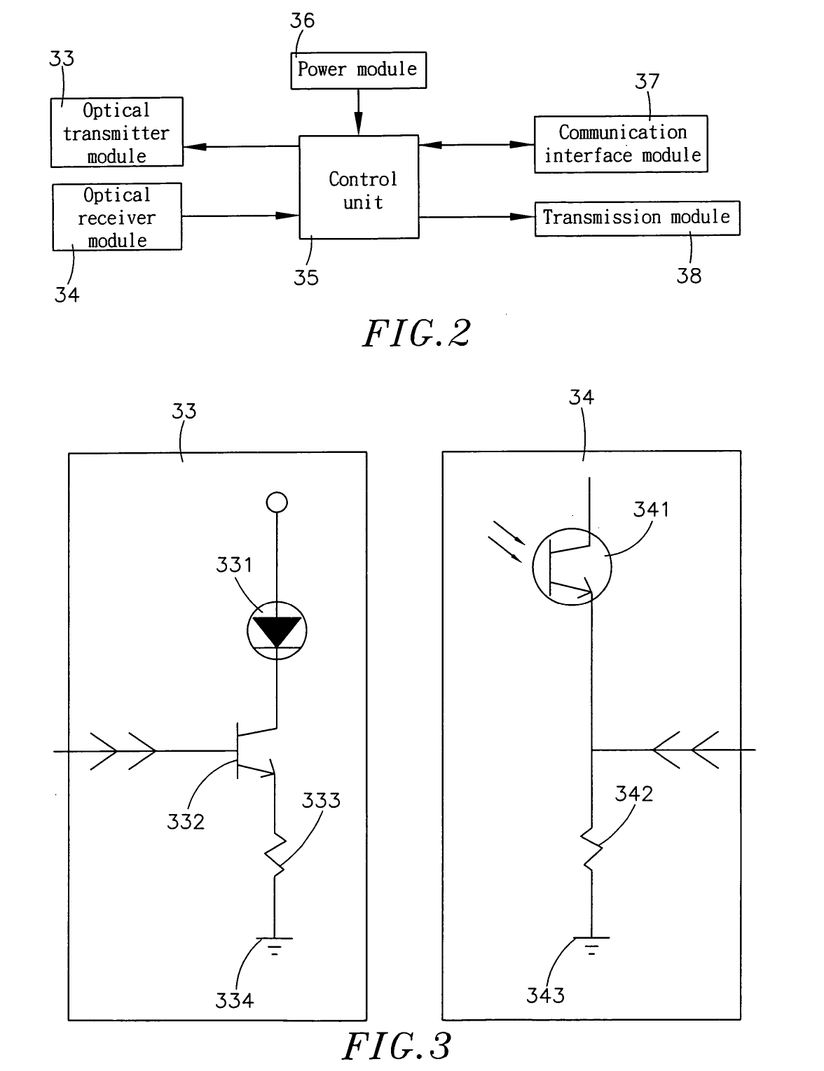

Referring to FIGS. 1, 1A, 2 and 3, the power module 36 is adapted to convert external power supply (not shown) into the desired working voltage for the optical transmitter module 33, the optical receiver module 34, the control unit 35, the communication interface module 37, and the transmission module 38. The communication interface module 37 is connectable to a main unit (not shown). The main unit (which can be a computer, coin exchanger, or vending machine) can be operated to set the operation mode of the control unit 35, enabling the control unit 35 to control the operation of the optical transmitter module 33, the optical receiver module 34, the communication interface module 37, and the transmission module 38. The transmission module 38 is adapted to drive the aforesaid banknote conveyer 12 to deliver the verified banknote into the banknote passage 13 of the housing 1.

Referring to FIG. 3, the optical transmitter module 33 further comprises a NPN transistor 332 and a current-limit resistor 333. The base of the transistor 332 is connected to the control unit 35. The collector of the transistor 332 is connected to the ultraviolet LED 331. The emitter of the transistor 332 is connected to one end of the current-limit resistor 333. The other end of the current-limit resistor 333 is connected to a grounding loop 334. By means of the transistor 332 and the current-limit resistor 333, the control unit 35 controls the flowing of electric current to the ultraviolet LED 331 so as to further control the light intensity of the ultraviolet LED 331.

Referring to FIG. 3, the optical receiver module 34 further comprises a shunt resistor 342, which has one end connected to the phototransistor 341 and the control unit 35, and the other end connected to the grounding loop 343. The shunt resistor 342 controls the phototransistor 341 to regulate output voltage and to transmit the detected fluorescent signal to the control unit 35.

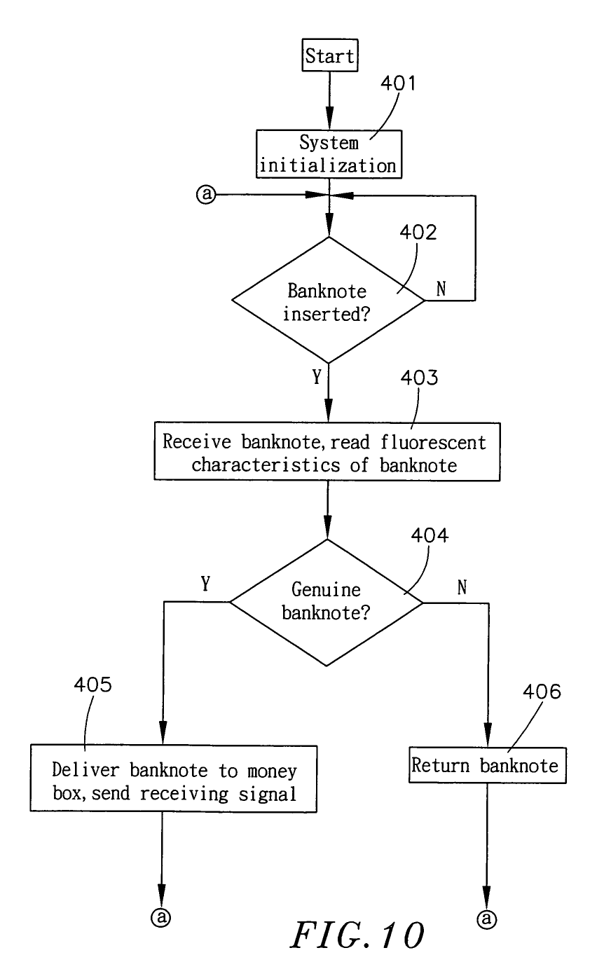

Referring to FIG. 10, when the banknote verification assembly 3 starts to verify the authenticity of the inserted banknote, the control unit 35 proceeds subject to the following steps:

(401) initializing the system;

(402) determining if there is a banknote to be verified or not? And then proceeding to step (403) if positive, or repeating step (402) if negative;

(403) receiving the inserted banknote and reading the fluorescent characteristics of the banknote;

(404) determining the authenticity of the banknote subject to the detected fluorescent characteristics, and then proceeding to step (405) if positive or step (406) if negative;

(405) delivering the banknote to the money box and sending a receiving signal, and then repeating step (402); and

(406) returning the banknote, and then repeating step (402).

As indicated above, the invention provides a banknote acceptor, which has the following benefits:

1. The invention verifies the authenticity of the inserted banknote by means of the radiation of ultraviolet light without the application of an additional specific area pickup and equation calculation procedure. This banknote verification procedure is simple, providing high accuracy and reliability.

2. Banknotes of different values have different lengths and widths, and employ different anti-counterfeit techniques. The housing of the banknote acceptor can be detachably selectively attached with one of a set of banknote verification assemblies that fit different kinds of banknotes issued from different banks in different countries.

3. The banknote acceptor of the present invention uses an ultraviolet LED to provide ultraviolet light for verifying the authenticity of the inserted banknote for the advantages of no warm-up time, quick reaction speed, small size, low power consumption, low pollution, high brightness, and long service life. The use of the ultraviolet LED enhances the accuracy and reliability of the banknote authenticity verification operation.

4. The ultraviolet light radiation arrangement in banknote authenticity verification according to the present invention does not need an additional precision array calculation, and is practical for use in a regular automatic vending machine or coin exchanger, simplifying the installation and fabrication of the machine and lowering its manufacturing cost.

A prototype of banknote acceptor has been constructed with the features of FIGS. 1˜10. The banknote acceptor functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A banknote acceptor for use in an automatic vending machine/coin exchanger, comprising:
a housing, said housing comprising an insertion slot in a face panel thereof for the insertion of a banknote, a banknote passage, said banknote passage having a front end in communication with said insertion slot and a rear end, a banknote holding down mechanism provided at the rear end of said banknote passage, said banknote holding down mechanism comprising a holding down plate for forcing a banknote out of said banknote passage into a money box and holding the banknote in place, and conveyer means adapted to deliver a banknote from said insertion slot through said banknote passage to said banknote holding down mechanism;
a money box connected to said housing for receiving each banknote from said banknote holding down mechanism; and
a banknote verification assembly mounted in said housing and adapted to verify the authenticity of a banknote being inserted into said insertion slot for enabling the verified banknote to be delivered to said banknote passage and then said banknote holding down mechanism, said banknote verification assembly comprising:
a transmitter holder base, said transmitter holder base having a detection side;
a receiver holder base, said receiver holder base having a detection side facing the detection side of said transmitter holder base and defining a banknote path in communication between said insertion slot and said banknote passage;
an optical transmitter module mounted in the detection side of said transmitter holder base and facing said banknote path, said optical transmitter module comprising at least one ultraviolet light emitting diode adapted to emit ultraviolet light onto the banknote being inserted into said insertion slot and said banknote path;
an optical receiver module mounted in the detection side of said receiver holder base and facing said banknote path, said optical receiver module comprising at least one phototransistor adapted to receive ultraviolet light passed from said optical transmitter module through the banknote being inserted into said insertion slot and said banknote path and to produce a corresponding output signal carrying fluorescent characteristics of the banknote;
a control unit adapted to receive the outputted signal of said optical receiver module and to compare the characteristics of the banknote with a reference value set therein so as to determined the authenticity of the received banknote; and
a communication interface module adapted to connect said control unit to an external main unit for enabling the external main unit to edit said reference value.

2. The banknote acceptor as claimed in claim 1, wherein said banknote verification assembly is removable from said housing for a replacement.

3. The banknote acceptor as claimed in claim 1, wherein said money box comprises a banknote receiving opening facing the holding down plate of said banknote holding down mechanism, a plurality of spring members, and a bearing board supported on said spring members and facing said holding down plate for receiving banknotes from said banknote holding down mechanism.

4. The banknote acceptor as claimed in claim 1, wherein said optical transmitter module comprises a NPN transistor and a current-limit resistor, said NPN transistor having a base electrically connected to said control unit, a collector electrically connected to said at least one ultraviolet light emitting diode, and an emitter electrically connected to said current-limit resistor, said current-limit resistor having a first end electrically connected to the emitter of said NPN transistor and a second end electrically connected to a grounding loop for enabling said control unit to control the light intensity of ultraviolet light of said at least one ultraviolet light emitting diode.

5. The banknote acceptor as claimed in claim 1, wherein said optical receiver module comprises a shunt resistor, said shunt resistor having a first end electrically connected to said at least one photo transistor and said control unit and a second end electrically connected to the grounding loop to which said current-limit resistor is connected.

6. The banknote acceptor as claimed in claim 1, wherein said control unit controls the operation of said optical transmitter module, said optical receiver module, said communication interface module and said transmission module subject to an operating program set therein.

7. The banknote acceptor as claimed in claim 1, wherein said banknote verification assembly is adapted to detect the fluorescent reaction of fluorescent filaments of the paper material of each banknote being inserted into said insertion slot and said banknote path.

8. The banknote acceptor as claimed in claim 1, wherein said banknote verification assembly is adapted to detect fluorescent reaction of the ink of each banknote being inserted into said insertion slot and said banknote path.

9. The banknote acceptor as claimed in claim 1, further comprising security means adapted to prohibit a person from pulling bank the inserted banknote out of said insertion slot.

10. The banknote acceptor as claimed in claim 1, wherein said banknote verification assembly further comprises a power module adapted to convert an external power supply into a predetermined voltage for the working of said optical transmitter module, said optical receiver module, said control unit, said communication interface module, and said transmission module.

11. The banknote acceptor as claimed in claim 1, wherein the external main unit to which said communication interface module is to be connected can be a computer, coin exchanger, automatic vending machine, cell phone, or programmable electronic apparatus.
